(19) United States
(12) Patent Application Publication
(10) Pub. No.: US 2013/0074707 A1
(43) Pub. Date: Mar. 28, 2013

(54) HORIZONTAL JUICER WITH COMPRESSION STRAINER DEVICE

(71) Applicant: Greenfield World Trade, Inc., Weston, FL (US)

(72) Inventors: Neal Asbury, Weston, FL (US); Dong Un Kim, Rochester, MI (US)

(73) Assignee: GREENFIELD WORLD TRADE, INC., Weston, FL (US)

(21) Appl. No.: 13/628,809

(22) Filed: Sep. 27, 2012

Related U.S. Application Data
(60) Provisional application No. 61/539,543, filed on Sep. 27, 2011.

(51) Int. Cl. A23N 1/00

(52) U.S. Cl. 99/495

(57) ABSTRACT

A horizontal juicer for extracting juice from a food includes a base housing a motor and an extracting unit. The extracting unit is disposed adjacent the base. The horizontal juice includes a compression chamber having at least one first strainer disposed at a first end of the compression chamber, at least one second strainer disposed at a second end of the compression chamber. An intermediate portion is disposed between the at least one first strainer and the at least one second strainer. An auger is disposed in the compression chamber. The auger has a blade disposed spirally around a first end of the auger and a plurality of ribs disposed at a second end of the auger.

### CROSS-REFERENCE TO RELATED APPLICATION

This application claims priority to U.S. Provisional Application Ser. No. 61/539,543, filed Sep. 27, 2011, the entire disclosure of which is hereby incorporated herein by reference.

### FIELD OF INVENTION

The present disclosure relates to an extractor, and more particularly to a horizontal juice extractor used for optimizing an amount of juice extracted from fruits and vegetables.

### BACKGROUND OF THE INVENTION

Various juicers are known in the prior art. Specifically, there are three main types of juicers: masticating, centrifugal, and triturating. Masticating juicers, or single gear juicers, grind the fibers of fruits and vegetables to extract more vitamins, enzymes, and minerals. Accordingly, the masticating juicers operate at slower speeds than other juicers.

Known masticating juicers are inefficient. For example, many masticating juicers include only one strainer, making it difficult to extract all of the juice out from various foods. Additionally, masticating juicers may not produce an optimal juice output due to residue from the foods blocking openings of the strainer, through which the juice is filtered. Furthermore, heat produced by the friction between various parts of the juicers may negatively affect the nutritional value of the juice output. Accordingly, the juice output, and likewise the nutrient yield, of conventional masticating juicers is lower than desired.

It is desirable to have a horizontal juice extractor that maximizes juice output and optimizes a nutritional content of the extracted juice.

### SUMMARY OF THE INVENTION

Consonant with the instant disclosure, a horizontal juice extractor that maximizes juice output and optimizes a nutritional content of the extracted juice has surprisingly been discovered.

In one embodiment, a horizontal juicer for extracting juice from a food includes a compression chamber having at least one first strainer disposed on a first end of the compression chamber. At least one second strainer is disposed at a second end of the compression chamber. An intermediate portion is disposed between the at least one first strainer and the at least one second strainer. The device also includes an auger disposed in the compression chamber.

In another embodiment, a horizontal juice extractor includes a compression chamber and an auger disposed in the compression chamber. The auger has at least one blade originating at a first end of the auger. The blade is disposed spirally around an outer surface of the auger. The auger also has plurality of ribs is disposed on the outer surface of the auger, and an intermediate portion having a first end disposed adjacent the first end of the auger and a second end disposed adjacent a second end of the auger. A diameter of the intermediate portion of the auger increases from the first end of the intermediate portion of the auger to a center of the intermediate portion of the auger. The diameter further decreases from the center of the intermediate portion of the auger to the second end of the intermediate portion of the auger.

In a further embodiment, a horizontal juice extractor includes a compression chamber having at least one first strainer disposed on a first end of the compression chamber. At least one second strainer is disposed at a second end of the compression chamber. An intermediate portion is disposed between the at least one first strainer and the at least one second strainer. The device also includes an auger disposed in the compression chamber. The auger has at least one blade originating at a first end of the auger. The blade is disposed spirally around an outer surface of the auger. The auger also has plurality of ribs is disposed on the outer surface of the auger, and an intermediate portion having a first end disposed adjacent the first end of the auger and a second end disposed adjacent a second end of the auger. A diameter of the intermediate portion of the auger increases from the first end of the intermediate portion of the auger to a center of the intermediate portion of the auger, and decreases from the center of the intermediate portion of the auger to the second end of the intermediate portion of the auger.

### DRAWINGS

The above, as well as other advantages of the present disclosure, will become readily apparent to those skilled in the art from the following detailed description, particularly when considered in the light of the drawings described hereafter.

FIG. 1 shows a cross-sectional side elevational view of a horizontal juice extractor according to one embodiment of the present disclosure;

FIG. 2 shows an exploded side perspective view of the horizontal juice extractor depicted in FIG. 1;

FIG. 3 shows an enlarged side perspective view of an auger of the juice extractor depicted in FIGS. 1 and 2;

FIG. 4 shows an enlarged side perspective view of a compression chamber of the juice extractor depicted in FIGS. 1 and 2;

FIG. 5 shows a cross-sectional side elevational view of the compression chamber of the juice extractor shown in FIG. 4; and

FIG. 6 shows a fragmentary cross-sectional side elevational view of an opening in a screen of the compression chamber taken at call out 6 in FIG. 5.

### DETAILED DESCRIPTION OF THE INVENTION

The following detailed description and appended drawings describe and illustrate various exemplary embodiments of the invention. The description and drawings serve to enable one skilled in the art to make and use the invention, and are not intended to limit the present disclosure, application, or uses. It should also be understood that throughout the drawings, corresponding reference numerals indicate like or corresponding parts and features.

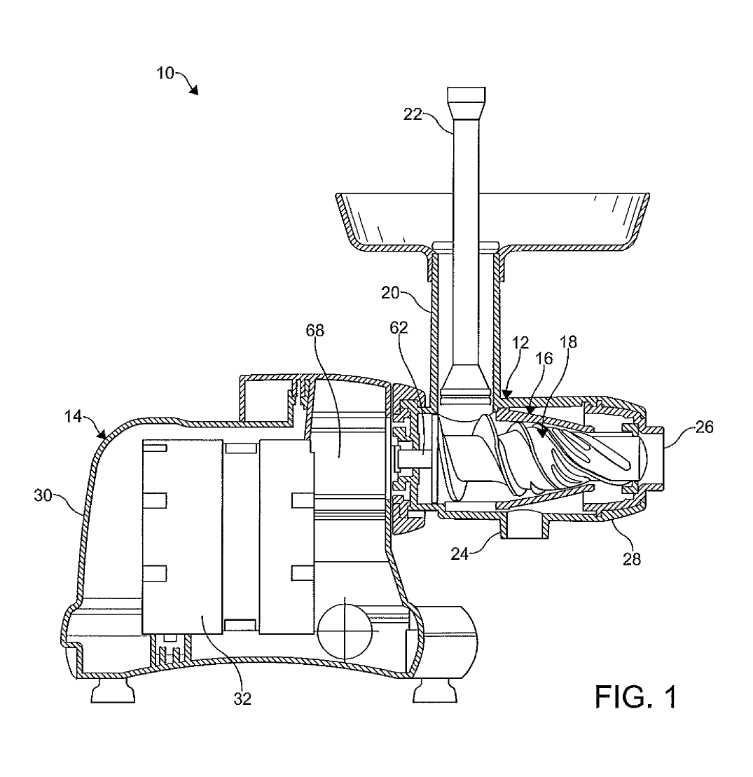

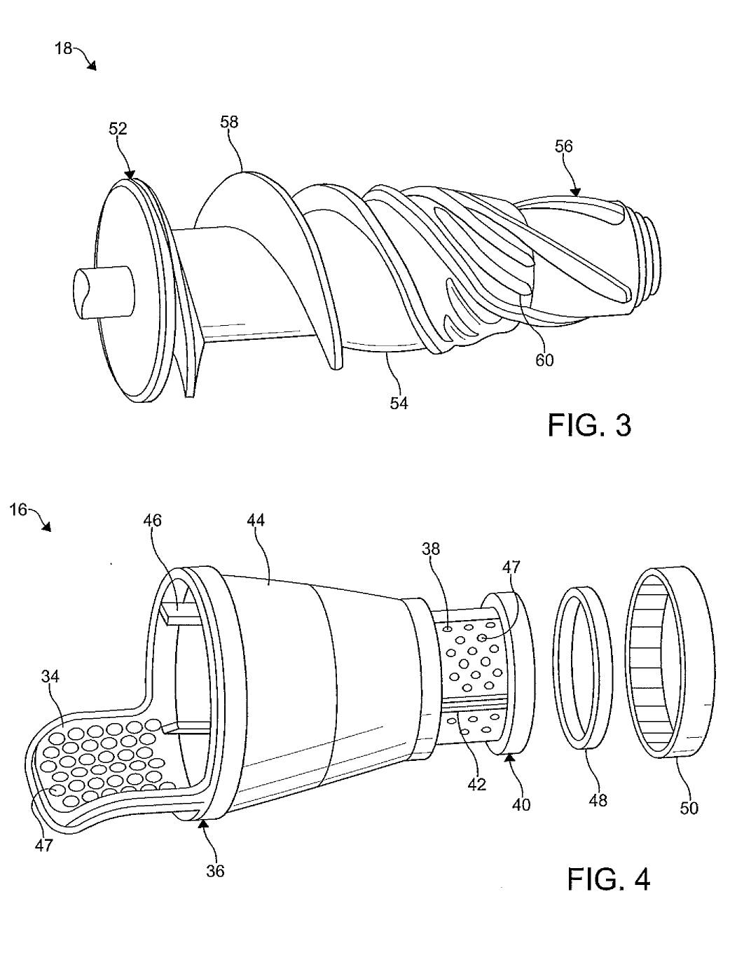

FIGS. 1-6 illustrate a juice extractor 10. The juice extractor 10 includes an extracting unit 12, a base 14, a compression chamber 16, and an auger 18. The juice extractor 10 may be used to extract a juice from foods such as fruits and vegetables, for example.

The extracting unit 12 may be produced from a polycarbonate material but may be formed from other material such as metal or another type of plastic, as nonlimiting examples. The extracting unit 12 may be any size and shape capable of housing the compression chamber 16 and the auger 18. Various suitable materials, sizes, and shapes for the extracting unit 12 are contemplated and may be used within the scope of the present disclosure.

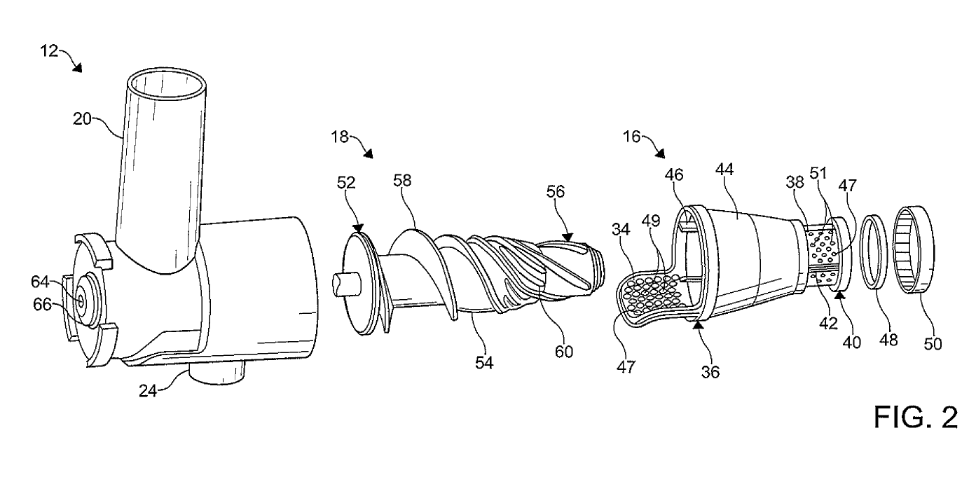

As shown in FIG. 2, the extracting unit 12 may include a feed channel 20 through which the food is passed. An insert 22 (shown in FIG. 1) may be used to force the food through the feed channel 20 if necessary. A juice outlet 24 is formed in a bottom surface of the extracting unit 12, and a residue outlet 26 extends outwardly from the extracting unit 12 at a first end of the extracting unit 12 opposite the base 14. An end cap 28 may be disposed on the first end of the extracting unit 12. The end cap 28 may be integral with, or a separate component from, the residue outlet 26. The feed channel 20, the juice outlet 24, the residue outlet 26, and the end cap 28 may be permanently or removably connected to the extracting unit 12, and may be made from the polycarbonate material or a different suitable material, as desired.

The base 14 may include a shell 30 and a motor 32. The base 14 may be removably connected to the extracting unit 12 at a second end of the extracting unit 12. The shell 30 may be produced from the polycarbonate material or a different suitable material. The shell 30 may be any size and shape capable of housing the motor 32 and providing stability to the juice extractor 10 in operation.

The motor 32 is configured to actuate the auger 18. As nonlimiting examples, the motor 32 may be an electrical motor such as an induction motor, for example, powered by battery, or any other motor capable of producing the required wattage, current, and the like, to rotate the auger 18. In other embodiments, the motor 32 is in electrical communication with an external power source such as an electrical outlet via an electrical cord with a plug. The motor 32 may include a control device (not shown) for actuating the auger 18.

A juice container and a residue container (not shown) may also be included in the juice extractor 10. The juice container is removably connected to the extracting unit 12 or the base 14 and positioned under the juice outlet 24. Likewise, the residue container is removably connected to the extractor unit 12 or the base 14 and is positioned adjacent to, or under, the residue outlet 26. The juice container and the residue container may be formed from the polycarbonate material or a different material, as desired.

The compression chamber 16 is housed in the extractor unit 12. The compression chamber 16 may be conically shaped, for example, as shown in FIG. 2. Other suitable shapes capable of receiving the auger 18 may also be employed within the scope of the present disclosure.

In one embodiment, an at least one first strainer 34 extends outwardly from a first end 36 of the compression chamber 16. The first end 36 of the compression chamber 16 is disposed adjacent the base 14. An at least one second strainer 38 is located at a second end 40 of the compression chamber 16, which is disposed opposite the first end 36. A diameter of the second end 40 of the compression chamber 16 is smaller than a diameter of the first end 36 of the compression chamber 16. A skilled artisan should understand that the at least one first strainer 34 and the at least one second strainer 38 may be formed from stainless steel or any other suitable material that is easy to clean and capable of withstanding pressure from the auger 18.

The at least one second strainer 38 has a plurality of ribs 42 disposed on an inner surface of the at least one second strainer 38. An intermediate portion 44 of the compression chamber 16 is disposed between the at least one first strainer 34 and the at least one second strainer 38. The intermediate portion 44 of the compression chamber 16 may be formed from a polyether amide or any other suitable material that is heat resistant with a high tensile strength, as desired.

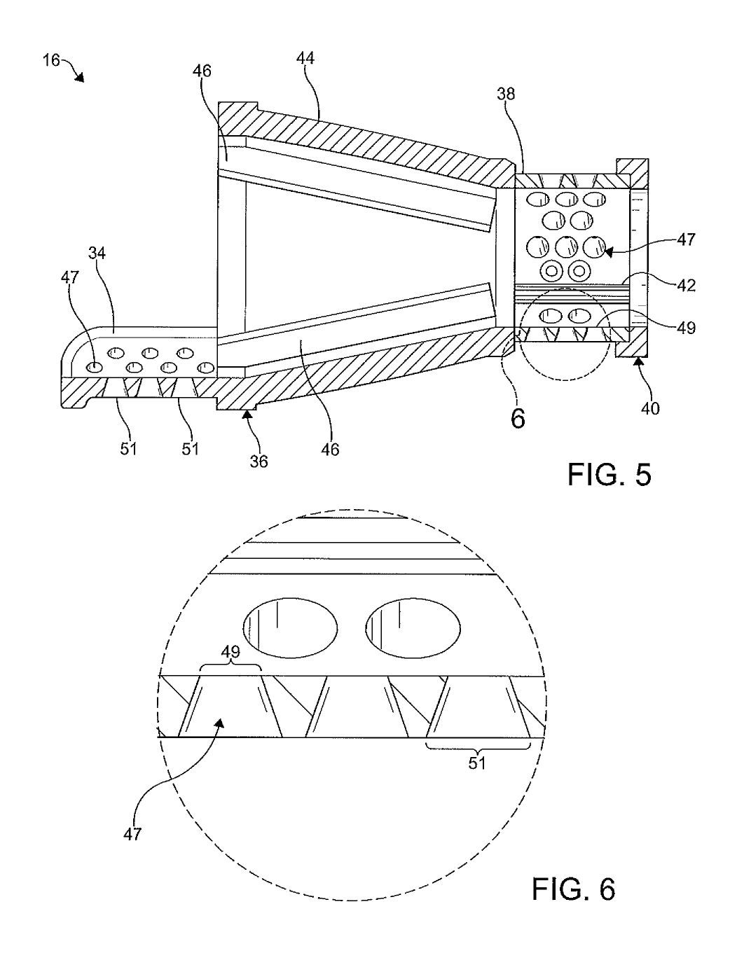

As shown in FIG. 5, the intermediate portion 44 has a plurality of lateral ribs 46 disposed on an inner surface of the compression chamber 16. The lateral ribs 46 extend inwardly from the inner surface toward a center of the compression chamber 16. A diameter of the intermediate portion 44 decreases from a first end of the intermediate portion 44 adjacent the at least one first strainer 34 to a second end of the intermediate portion 44 adjacent the at least one second strainer 38. The decreasing diameter results in an increase in pressure between the compression chamber 16 and the auger 18 as the food passes through the compression chamber to the at least one second strainer. Accordingly, a higher juice output may be obtained.

The at least one first strainer 34 and the at least one second strainer 38 include a plurality of openings 47. The openings 47 may be uniform in size and shape, or may vary. As shown in FIG. 6, a first diameter 49 of each opening 47 adjacent an area inside of the compression chamber 16 is smaller than a second diameter 51 of each opening 47 adjacent an area outside of the compression chamber 16. The smaller first diameter militates against food filtering through the at least one first strainer 34 and the at least one second strainer 38, and the larger second diameter optimizes the amount of juice filtered through the at least one first strainer 34 and the at least one second strainer 38.

A residue ring 48 is disposed on the second end 40 of the compression chamber. The residue ring 48 may be circular in shape. The residue ring 48 may be formed from a material such as silicone, for example. However, the residue ring 48 may be any suitable shape and made from any suitable material capable of withstanding axial pressure from a residue build-up in the compression chamber 16, as desired.

A sealing ring 50 may be disposed over a peripheral edge of the residue ring 48. The sealing ring 50 secures the residue ring 48 to the second end 40 of the compression chamber 16. It should be understood that the sealing ring 50 may be attached to the compression chamber in any appropriate manner. The sealing ring 50 may be threadably connected to the compression chamber 16, or may friction fit with the intermediate portion 44 of the compression chamber 16, as nonlimiting examples.

The auger 18 is disposed in the compression chamber 16 and may be produced from a heat resistant, high tensile strength material such polyether imide, for example. Other suitable materials for the auger 18 may also be employed within the scope of the disclosure.

As shown in FIG. 2, the auger 18 has a first end 52, a second end 56, and an intermediate portion 54 disposed between the first end 52 and the second end 56. A diameter of the intermediate portion 54 increases from a first end of the intermediate portion 54 adjacent the first end 52 of the auger 18 to a center of the intermediate portion 54. The diameter of the intermediate portion 54 then decreases from the center of the intermediate portion 54 to a second end of the intermediate portion 54 adjacent the second end 56 of the auger 18. Accordingly, as the diameter of the intermediate portion 54 of the auger 18 increases, the diameter of the intermediate portion 44 of the compression chamber 16 decreases, and the food is further extracted due to an increase in pressure between the auger 18 and the compression chamber 16. At least one blade 58 extends outwardly from an outer surface of auger 18. The at least one blade 58 is arranged in a spiraling configuration around the auger 18. A width of the blade 58 decreases as the blade 58 extends from the first end 52 of the auger 18 to the second end 56 of the auger 18. A plurality of ribs 60 is disposed on the outer surface of the intermediate portion 54 and the second end 56 of the auger 18. In certain embodiments, the plurality of ribs 60 may be disposed on the intermediate portion 54 of the auger 18 between the center of the intermediate portion 54 and the second end of the intermediate portion 54. The plurality of ribs 60 are disposed adjacent a portion of the at least one blade 58 and may be curvilinear in shape. The plurality of ribs 60 further extracts juice from the food by pressing against the decreasing diameter of the intermediate portion 44 of the compression chamber 16.

With renewed reference to FIG. 1, a transmission shaft 62 extends through the center of the auger 18 and is powered by the motor 32. In some embodiments, the transmission shaft 62 may be connected to the first end 52 of the auger 18. The transmission shaft 62 may extend through an aperture 64 located at a center of the second end of the extractor unit 12 opposite the first end of the extractor unit 12. The transmission shaft 62 connects the auger 18 to the motor 32. A center sealing ring 66 may be disposed around the aperture 64 to prevent juice from spilling into the base 14, A pin (not shown) may be used to orient the transmission shaft 62 and the auger 18 in a specific axial and radial position in the center of the extractor unit 12.

A gear system 68 is disposed in the base 14 and may include a gear head, a gear shaft, and a gear face (not shown). The gear system 68 may be produced from metal or any other material capable of withstanding pressure from continued rotation of the auger 18. The gear system 68 operatively connects the motor 32 to the transmission shaft 62.

in operation, food is inserted into the feed channel 20 and the motor 32 is turned on. The motor 32 rotates the transmission shaft 62 of the auger 18, causing the auger 18 to rotate. The insert 22 may be used to force the food through the feed channel 20. The food enters the extractor unit 12 and contacts the first end of the auger 18. The juice is initially extracted from the food by a widest portion of the blade 58 disposed at the first end 52 of the auger 18. The juice extracted at the first end 36 of the compression chamber 16 exits the compression chamber 16 through the at least one first strainer 34. As the food passes further into the compression chamber 16, the width of the blade 58 decreases, the diameter of the intermediate portion 54 of the auger 18 increases, and the diameter of the intermediate portion of the compression chamber 16 decreases. Accordingly, juice is further extracted from the food by an increased pressure between the intermediate portion 54 of the auger 18, including the ribs 60, and the intermediate portion 44 of the compression chamber 16, including the ribs 46.

As food passes through to the second end 40 of the compression chamber 16, an increased pressure between the second end 56 of the auger 18, including ribs 60, and the second end 40 of the compression chamber 18, including the ribs 42, extracts additional juice. The juice exits the compression chamber 16 through the at least one second screen 38. The smaller first diameter 49 of each opening 47 militates against a residue exiting the compression strainer 16 with the juice, and the larger second diameter 51 of each opening 47 allows more juice to filter through the at least one first strainer 34 and the at least one second strainer 38. The residue build-up forms at the second end 40 of the compression chamber 16 against the residue ring 48. The residue ring 48 militates against the residue build-up exiting the compression chamber 16 until an adequate pressure is built up in the compression chamber 16. Accordingly, the residue seal 48 allows for more juice to be extracted from the residue by preventing the residue from exiting the compression chamber 16, until desired.

The gear system 20 in combination with the transmission shaft 62 increases the power of the rotating auger 18 and decreases the speed at which the auger 18 rotates. Ideally, the gear system 20 reduces the speed at which the transmission shaft 62 rotates the auger 18 by a reduction ratio of about 22.6:1. Accordingly, the auger 18 rotates at a speed of about 80 rpm with a force of about 38.65 Nm. However, the speed at which the auger 18 rotates may vary within the scope of the instant disclosure. The ribs 60 disposed on the auger 18 may also be selected to slow down the speed at which the auger 18 rotates.

The slower speed at which the auger 18 rotates desirably results in a maximized squeezing time and a higher juice output. The residue seal 48 also contributes to the maximized squeezing time by preventing the residue from exiting the compression chamber 16 until desired. The increased power of the auger 18 allows for an improved extraction of the juice from the food. Additionally, the openings 47 prevent residue from exiting the compression chamber 16 with the juice output, which improves a quality of the juice output. Furthermore, the slower speed at which the auger 18 rotates reduces a build-up of heat caused by friction between the auger 18 and the compression chamber 16, minimizing a degradation of nutrients, and allowing for an optimal nutritional content of the juice output.

While certain representative embodiments and details have been shown for purposes of illustrating the invention, it will be apparent to those skilled in the art that various changes may be made without departing from the scope of the disclosure, which is further described in the following appended claims.

What is claimed is:

1. A horizontal juicer for extracting juice from a food, comprising:
a compression chamber including at least one first strainer disposed on a first end of the compression chamber, at least one second strainer disposed at a second end of the compression chamber, and an intermediate portion disposed between the at least one first strainer and the at least one second strainer; and
an auger disposed in the compression chamber.

2. The horizontal juicer of claim 1, wherein the intermediate portion of the compression chamber and the second end of the compression chamber include a plurality of ribs on an inner surface of the compression chamber.

3. The horizontal juicer of claim 1, wherein at least one blade is disposed spirally around the auger.

4. The horizontal juicer of claim 1, wherein the compression chamber is substantially conical.

5. The horizontal juicer of claim 1, including a residue seal disposed on the second end of the compression chamber and militating against a food residue exiting the compression chamber in operation.

6. The horizontal juicer of claim 1, wherein a plurality of ribs is disposed on the auger adjacent the at least one blade.

7. The horizontal juicer of claim 1, wherein the at least one first strainer and the at least one second strainer have a plurality of openings.

8. The horizontal juicer of claim 7, wherein a first diameter of each of the openings disposed adjacent an area inside of the compression chamber is smaller than a second diameter of each of the openings disposed adjacent an area outside of the compression chamber.

9. A horizontal juicer for extracting juice from a food, comprising:
a compression chamber; and
an auger disposed in the compression chamber, the auger having at least one blade originating at a first end of the auger and disposed spirally around an outer surface of the auger, a plurality of ribs disposed on the outer surface of the auger, and an intermediate portion having a first end disposed adjacent the first end of the auger and a second end disposed adjacent a second end of the auger,
wherein a diameter of the intermediate portion of the auger increases from the first end of the intermediate portion of the auger to a center of the intermediate portion of the auger and decreases from the center of the intermediate portion of the auger to the second end of the intermediate portion of the auger.

10. The horizontal juicer of claim 9, wherein a width of the at least one blade decreases as the at least one blade extends from the first end of the auger to the second end of the auger.

11. The horizontal juicer of claim 9, wherein the plurality of ribs is disposed on the intermediate portion of the auger and the second end of the auger.

12. The horizontal juicer of claim 11, wherein the plurality of ribs is disposed on the intermediate portion of the auger between the center of the intermediate portion and the second end of the intermediate portion.

13. The horizontal juicer of claim 9, wherein each rib of the plurality of ribs is curvilinear in shape.

14. The horizontal juicer of claim 9, wherein a motor is connected to a gear system and the gear system rotates a transmission shaft connected to the auger.

15. The horizontal juicer of claim 14, wherein the motor, in combination with the gear system, causes the transmission shaft to rotate the auger an optimal speed.

16. The horizontal juicer of claim 15, wherein the speed at which the auger rotates is about 80 revolutions per minute.

17. A horizontal juice extractor, comprising:
a compression chamber including at least one first strainer disposed on a first end of the compression chamber, at least one second strainer disposed at a second end of the compression chamber, and an intermediate portion disposed between the at least one first strainer and the at least one second strainer; and
an auger disposed in the compression chamber, the auger having at least one blade originating at a first end of the auger and disposed spirally around an outer surface of the auger, a plurality of ribs disposed on the outer surface of the auger, and an intermediate portion having a first end disposed adjacent the first end of the auger and a second end disposed adjacent a second end of the auger;
wherein a diameter of the intermediate portion of the auger increases from the first end of the intermediate portion of the auger to a center of the intermediate portion of the auger and decreases from the center of the intermediate portion of the auger to the second end of the intermediate portion of the auger.

18. The juice extractor of claim 17, wherein a gear system including a transmission shaft is connected to the auger, and wherein a motor, in combination with the gear system, causes the transmission shaft to rotate the auger at a speed of about 80 revolutions per minute.

19. The juice extractor of claim 17, wherein the gear system reduces a speed at which the transmission shaft rotates the auger by a reduction ratio of about 22.6 to 1.

20. The juice extractor of claim 17, wherein a residue seal is disposed on the second end of the compression chamber and militates against a food residue exiting the compression chamber in operation.
